(19) United States
(12) Patent Application Publication
(10) Pub. No.: US 2013/0220380 A1
(43) Pub. Date: Aug. 29, 2013

(54) HOT AIR INJECTOR CLEANING SYSTEM AND PROCESS

(71) Applicants: DEREK KELLAR, Mabank, TX (US); JAMES BLUST, San Diego, CA (US); FRANK RITZ, San Diego, CA (US)

(72) Inventors: DEREK KELLAR, Mabank, TX (US); JAMES BLUST, San Diego, CA (US); FRANK RITZ, San Diego, CA (US)

(73) Assignee: Solar Turbines Incorporated, San Diego, CA (US)

(21) Appl. No.: 13/568,206

(22) Filed: Aug. 7, 2012

Related U.S. Application Data
(60) Provisional application No. 61/604,725, filed on Feb. 29, 2012.

(51) Int. Cl. B08B 9/027

(52) U.S. Cl. 134/22.12; 134/105

(57) ABSTRACT

A system and process for cleaning a flow passage of a dirty device, such as a fuel injector, are provided. The dirty device has one or more flow passages undesirably clogged with deposit layers of carbon, sulfur, and other contaminants. The device is placed within a thermal chamber heats the device to a first temperature. A fluid supply provides pressurized fluid having an oxidizer, and a heat exchanger heats the pressurized fluid to a second temperature. A conduit is coupled between the heat exchanger the flow passage of the device. The device is heated at the first temperature by the thermal chamber and heated fluid at the second temperature is supplied to the flow passage of the device. The thermal chamber can provide heat to the heat exchanger and the device simultaneously for a period of time.

### CROSS-REFERENCE TO RELATED APPLICATION

This application claims the benefit of prior provisional patent application Ser. No. 61/604,725 filed Feb. 29, 2012.

### TECHNICAL FIELD

The present disclosure relates generally to a system and process for cleaning one or more internal passageways of a device and more particularly to a hot air cleaning system and process for a device with one or more internal passageways coated with carbon-like substances, such as a fuel injector.

### BACKGROUND

Gas turbine engines include a plurality of fuel injectors, e.g., 10-21 fuel injectors, that supply a mixture of fine liquid fuel or gas droplets and air to the engine. During vaporization of liquid fuel or gas in a flow passage, deposits of carbon, sulfur, traces of metal, and/or heavy hydrocarbons accumulate on the passage walls as deposit layers. The rate at which these deposit layers thicken can be a function of passage wall temperature, fuel flow rate, and fuel type. As a result, the flow of fuel or gas through the devices can be severely restricted by the thickening deposit layers, which ultimately can lead to partial or complete clogging of the flow passages. Consequently, the devices perform less than ideal and must eventually be replaced with a new device or with an overhauled device. Fuel additives have been added to the fuel to reduce the rate of deposit layer accumulation. Even so, the flow passages still become dirty and clogged. To overhaul such device, it is common to apply cleaners to the layers along the flow passage, to oxidize the layers, or even apply a strong base solution that penetrate and breakdown the deposit layers.

In one example, the device can be placed in furnaces and heated to a hot temperature of about 1200-1400 degrees F. After cool down, the flow passage of the device is blown with room temperature cool air. To ensure effective performance of the cleaned devices, each cleaned device is subjected to flow and pressure drop experiments. However, it has been found that only up to about 25-50% of the cleaned devices successfully meet effective performance standards, leaving the remaining devices for disposal. One example of a fuel valve cleaning means for diesel engines is described in Japanese Pat. App. Publ. No. JP 59180060A. The publication describes injecting compressed air into a cylinder during engine startup to prevent the adhesion of carbon flower and remove adhered carbon flower without removing the fuel valve.

It would be desirable to provide a cleaning system and process that may be performed cost effectively (less expensive than the cost of new replacement devices), rapidly for quicker overhaul processes, and in compliance with various chemical use and disposal regulations. The embodiments described herein are directed at overcoming one or more disadvantages associated with prior cleaning systems and processes.

### SUMMARY

A system and process for cleaning a flow passage of a dirty device, such as a fuel injector, are provided. The dirty device has one or more flow passages undesirably clogged with deposit layers of carbon, sulfur, and other contaminants In one example, a cleaning system can include a thermal chamber to receive a device. The thermal chamber may be operable to heat the device to a first temperature. A fluid supply can provide a pressurized fluid that may include an oxidizer. A heat exchanger can be coupled to the fluid supply. The heat exchanger may be operable to heat the fluid to a second temperature. One or more conduits can be coupled to the heat exchanger and at least partially disposed within the thermal chamber to couple to one or more corresponding flow passages of the device. The fluid supply, the heat exchanger, the conduit, and the flow passage of the device may be in fluid communication with one another. Heat at the first temperature can be provided to the device by the thermal chamber. Heated fluid at the second temperature can be provided to the flow passage of the device. In one example, the heat exchanger may be disposed within the thermal chamber such that heat at the first temperature is provided to the heat exchanger by the thermal chamber to heat the pressurized fluid to the second temperature.

In one example, the disclosure is directed to a process of cleaning a flow passage of a device. The device can be disposed within a thermal chamber that may be operable to provide heat at a first temperature. A supply of pressurized fluid that may include an oxidizer may be provided. One step may be applying heat at a first temperature to a device for a first period of time. Another step may be supplying pressurized fluid at a second temperature to a flow passage of the device for a second period of time. At least a portion of the first period of time and the second period of time may overlap one another. In one example, a heat exchanger may be provided within the thermal chamber. To this end, pressurized fluid at a third temperature may be supplied to the heat exchanger such that the pressurized fluid is heated to the second temperature prior to being supplied to the flow passage of the device. Another step may be applying heat at the first temperature to the device and to the heat exchanger such that the pressurized fluid is heated to the second temperature.

### BRIEF DESCRIPTION OF THE DRAWINGS

FIG. 1 is a schematic diagram of one example of a cleaning system.

FIG. 2 is an illustration of another example of a cleaning system including a support structure within a thermal chamber.

FIG. 3 is a perspective view of a support structure supporting more than one device.

FIG. 4 is a schematic diagram of another example of a cleaning system.

FIG. 5 is a schematic diagram of yet another example of a cleaning system.

FIG. 6 is a schematic diagram of another example of a cleaning system with inductive heating.

FIG. 7 is a schematic illustrating one example of a cleaning process.

Although the drawings depict exemplary embodiments or features of the present disclosure, the drawings are not necessarily to scale, and certain features may be exaggerated in order to better illustrate and explain various embodiments of the present disclosure. The exemplifications set out herein illustrate exemplary embodiments or features of the disclosure and such exemplifications are not to be construed as limiting the scope of the disclosure in any manner.

### DETAILED DESCRIPTION

Reference will now be made in detail to various embodiments of the disclosure, examples of which are illustrated in the accompanying drawings. Wherever possible, the same reference numbers will be used throughout the drawings to refer to the same or like parts.

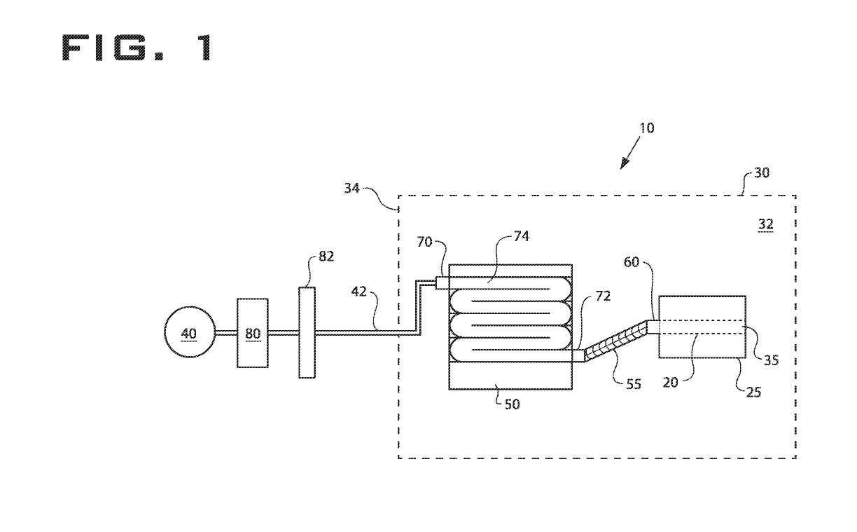

In FIG. 1, one example of a system 10 for cleaning one or more flow passages 20 (shown in dashed lines) of one or more dirty devices 25 is illustrated. One example of a dirty device may be one which has a flow passage undesirably clogged with deposit layers of contaminant such as, e.g., carbon, sulfur, traces of metal, hydrocarbons, or any combinations thereof The number of flow passages for each device can be any number, such as one, two, three, four, five or more passages. The system 10 can include a thermal chamber 30 (shown in dashed lines), such as a furnace. Several varieties of furnaces may be used, such as gas or electric air furnaces, so long as the furnace may be operable to reach the desired temperatures described herein.

The thermal chamber 30 may be operable to provide and maintain a heated environment of a first temperature within its cavity 32 for a first period of time. The device 25 can be placed anywhere within the cavity 32, which may be then fully enclosed, e.g., by closing the doors of the furnace. During the first period of time, the exterior of the device 25 may be heated to about the first temperature. The device 25 and/or the flow passage 20 can be heated by the thermal chamber 30 from an outside-in direction. One of advantages of providing heat in an outside-in direction can be to clean deposit layers off any external surfaces of the device 25 and/or easy-to-reach internal surfaces of the device 25.

As further described herein, the system 10 may be operable to provide a supply 35 (shown in dashed lines) of heated fluid at a second temperature to the flow passage(s) 20 of the device 25 for a second period of time. In other words, the device 25, and in particular the flow passage 20, can be heated by the supply 35 of heated fluid from an inside-out direction. The heated fluid may include an oxidizer. The reaction between the deposit layers and an oxidizer can convert the deposits to gas or a porous solid, thereby allowing for easier removal such as by the fluid movement. One of the advantages of the supply 35 of heated fluid may be the provision a constant or variable stream of a continuously replenishment of the oxidizer for reaction with the deposit layers. To this end, the supply 35 of fluid having an oxidizer may be not the rate-limiting step in the reaction. To increase the reaction rate between the supply 35 of fluid having the oxidizer and the deposit layers, the fluid can be heated as described herein. It can be noted that the provision of heat to the exterior of the device 25 as described herein in addition to heat through the flow passage may prevent the device 25 from becoming a heat sink. When the device becomes more a heat sink, the reaction rate between the supply 35 of fluid having the oxidizer and the deposit layers internally within flow passages of the device can be reduced.

The degree of first and second temperatures to maximize the reaction rate (carbon-oxygen, sulfur-oxygen, etc.) of the deposit layer without affecting the integrity of the device components can be based on several factors. The factors may include the temperature limits of the device components and materials and the constituency and thickness of the deposit layer lining the flow passage. The first and second temperatures can be equal or different, i.e., the first temperature can be lower or higher than the second temperature. In one example, the first temperature may be at least greater than the second temperature. The first and/or second temperatures can be as high as about 1200-1400 degrees F. (650-760 degrees C.). However, in another example, the first and/or second temperatures can be up to the sensitization temperature (when it is a factor), that is, the temperature at which sensitization of the metal of the device begins. For example, for stainless steel components the first temperature can be about 975±25 degrees F. (524±14 degrees C.). It has been found that when the first and/or second temperatures may be above about 1000 degrees F. (538 degrees C.) there may be an increased risk for sensitization, and below about 950 degrees F. (510 degrees C.) there may be a significant drop in reaction rate. The second temperature can be about 50 degrees F. (28 degrees C.), preferably about 15-35 degrees F. (9-20 degrees C.), and more preferably about 25 degrees F. (14 degrees C.) less than the first temperature.

The first and second periods of time can be consecutive, simultaneous, or overlapping, with the first or the second period time being the initial one. The first and second periods can be a different length or the same length of time. In one example, the first and second periods of time are simultaneous and of the same length, such as, e.g., about an hour. The time may be dependent upon the thickness of the deposit layer, reaction rates, and heat transfer rate. To this end, a thinner deposit layer may require less than an hour and a thicker deposit layer may require more than an hour.

The device 25 can be any device with a flow passage, such as a device that allows the passage of liquid fuel or gas. One example device may be a fuel injector. The fuel injector may be commonly configured for vaporizing a liquid fuel drawn from a supply of liquid fuel with oxygen drawn from an oxygen supply. The fuel injector includes one or more flow passages having an inlet end and an outlet end. The inlet end may have a port for coupling to the fluid supply 35. A valve (not shown) can be provided for placing the inlet end of the flow passage in fluid communication with the liquid fuel supply and introducing the liquid fuel in a substantially liquid state into the flow passage. Other components of the fuel injector are commonly known in the art.

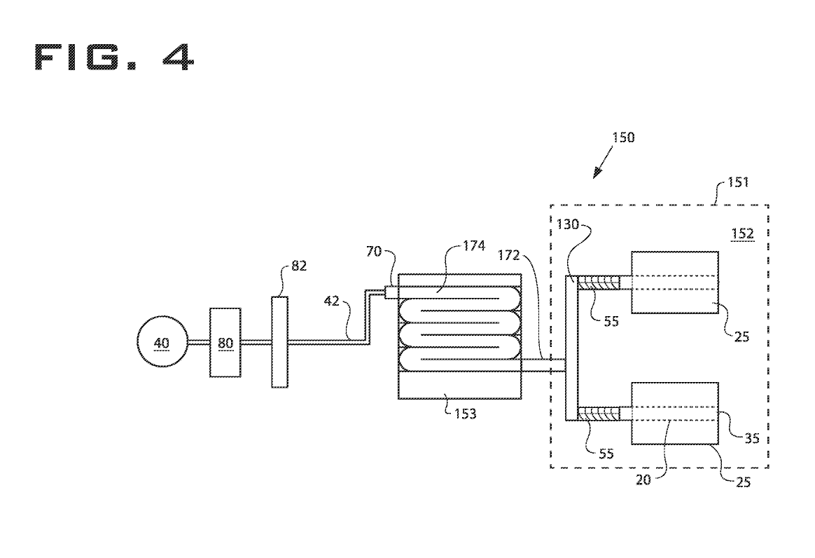

The supply 35 of heated fluid at the second temperature can be provided by various heating mechanisms. In one example, the fluid may be heated primarily from within the thermal chamber. In another example (see FIG. 4), the fluid may be heated prior to entry into the thermal chamber 30, for example, by an auxiliary heat source such as, e.g., a gas or electric furnace or a heat exchanger. In another example (see FIGS. 1, 5, and 6), the fluid may be heated within the cavity 32 of the thermal chamber 30. In yet another example, the fluid may be heated partially by the external auxiliary heat source prior to entry into the thermal chamber 30, and heated to the second temperature by the thermal chamber 30.

In one example, a fluid source 40 may be provided external to the thermal chamber 30 to supply the pressurized fluid supply 35. A fluid passageway 42 can traverse the walls 34 of the thermal chamber 30 to couple the fluid source 40 to a heat exchanger 50. The heat exchanger 50 can be disposed within the cavity 32 of the thermal chamber 20. A fluid conduit 55 can couple the heat exchanger 50 to the inlet end 60 of the flow passage 20 of the device 25, although the flow passage 20 may be directly coupled to the heat exchanger 50 without the use of the fluid conduit. To this end, the fluid source 40, the fluid passageway 42, the heat exchanger 50, the fluid conduit 55, and the flow passage 20 of the device 25 can be all in fluid communication with one another. The heat exchanger 50 may be operable to heat the fluid supply 35 up to about the second temperature, which can be up to about the first temperature of the thermal chamber.

The fluid supply 35 can be provided at a pressure sufficient to overcome any frictional losses due to the components in order to reach the flow passage 20. The fluid supply 35 can be provided at a third temperature that may be less than the second temperature. The heat exchanger 50 may be configured to transfer thermal energy from the thermal chamber 30 to the fluid supply 35 traveling therein. In effect, this raises the fluid supply temperature up to about the second temperature. Additional thermal energy may be transferred through the walls of the flow conduit 55, when employed, prior to the entry within the flow passage 20. The heat exchanger 50 can be any heat transfer device suitable for heating the fluid supply 35. For example, the heat exchanger 50 may include an inlet 70 coupled ultimately to the fluid source 40 and an outlet 72 coupled ultimately to the flow passage 20. A coil 74 formed in a serpentine pattern can be positioned between the inlet 70 and the outlet 72. The coil's cross-sectional area, wall thickness, and the overall length are sized appropriately for the desired heat transfer. In another example, the heat exchanger is a conduit.

In one example, the fluid source 40 may be shop air, that is, pressurized air at about 75 pounds-per-square inch (psi) (5 bar) used within a manufacturing facility for other application generally having the third temperature such that as ambient temperature or about 70 degrees F. (21 degrees C.). The third temperature can be higher than ambient when being heated by the thermal chamber prior to entry to the heat exchanger. To reduce the fluid supply pressure provided by the fluid source 40, a regulator 80 may be provided after the fluid source 40. For example, the fluid supply exiting the regulator 80 can be about 5-10 psi (0.3-0.7 bar). To clean the fluid prior to entry within the flow passage 20 of the device 25, a filter or degreaser 82 may be provided to facilitate in the reduction of oil and other contaminants within the fluid or degrease the fluid. The fluid passageway 42 can be coupled to the fluid source 40, the regulator 80, the filter 82, or any combination thereof.

The fluid conduit 55 can be flexible tubing, such as flexible metallic (e.g., stainless steel) tubing. The ends of the fluid conduit 55 can include any type of pneumatic or hydraulic fittings configured for coupling and decoupling from the outlet 72 of the heat exchanger 50 and/or the inlet end 60 of the flow passage 20 of the device 25 in a rapid manner. Transition adaptors fittings can be used to accommodate different sizes of the flow passage inlet ports.

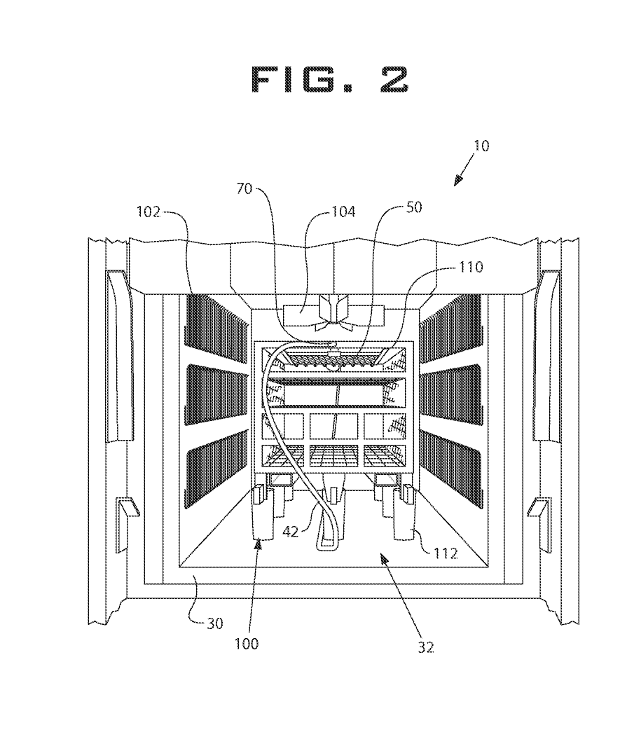

FIG. 2 illustrates one embodiment of the system 10 in more detail. Here, the cavity 32 of the thermal chamber 30 may be shown containing a support structure 100 that may be configured to support one or more devices 25 during the cleaning process and to maintain isolation of the device from the heating elements of the thermal chamber. The support structure 100 can be spaced from one or more heating elements 102 of the thermal chamber 30. The heating element 102 can provide along any wall of the thermal chamber 30, such as being disposed along sidewalls of the thermal chamber 30. The heating element 102 can provide heat radiation at the first temperature within the cavity 32 of the thermal chamber 30. A circulator 104, such as a fan, may be provided within the cavity 32 of the thermal chamber 30 to circulate heated air within the thermal chamber 30 provided by the heating element 102. For example, the circulator 104 can be provided along an upper wall of the thermal chamber 30.

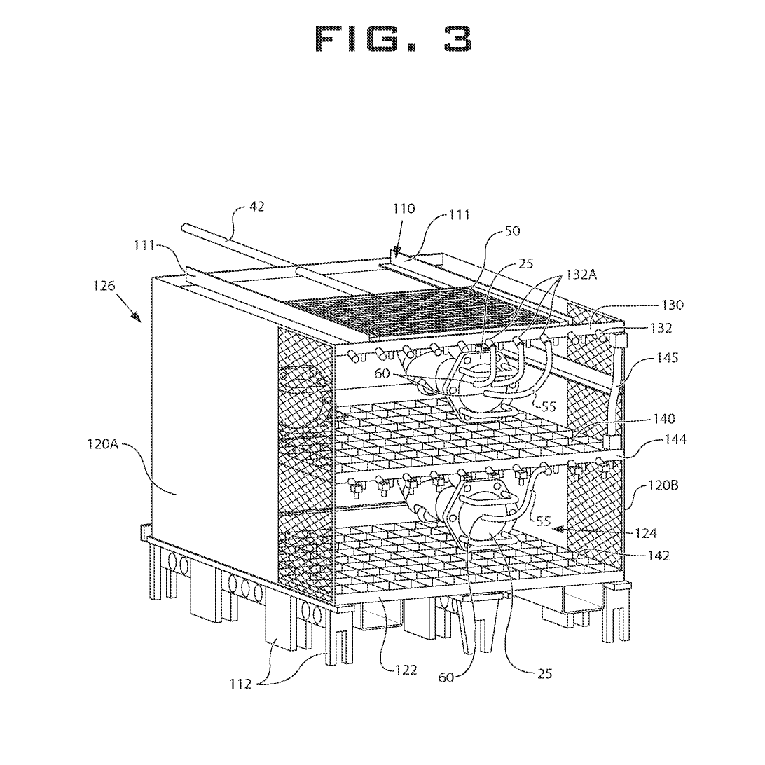

FIG. 2 depicts one end of the support structure 100. For instance, the fluid passageway 42 may be shown extending upward from the lower wall of the thermal chamber 30. The heat exchanger 50 can be disposed along an upper end 110 of the support structure 100, especially when the heat elements are disposed along the sidewalls of the thermal chamber. The support structure 100 can be spaced from the lower wall of the thermal chamber 30 with one or more leg elements 112. The heat exchanger 50 may be directly attached to the support structure 100. However, to accommodate for relative thermal expansion between the heat exchanger 50 and the support structure 100, the heat exchanger 50 may be placed on top of the support structure and remain unattached. In one example shown in FIG. 3, a pair of L-shaped bars 111 may form the upper end 110 of the support structure 100. The bars 111 can be laterally spaced, parallel, and oriented relative to one another at a distance to receive the heat exchanger 50. As shown, the support structure 100 can have multiple shelves to accommodate a plurality of devices 25 at once. It can also be appreciated that more than one heat exchanger can be placed within the thermal chamber. For example, each shelf may include its own heat exchanger. In another example, the heat exchanger(s) may be not associated with the support structure, but located within another zone of the thermal chamber.

FIG. 3 illustrates one embodiment of the support structure 100 removed from the thermal chamber 30. The support structure 100 can include a pair of sidewalls 120A, 120B, a lower wall 122 and the upper end 110 coupled between the sidewalls 120A-B. The components for the support structure can be made of expanded stainless steel metal, structural stainless steel, other metals or any combination thereof A front end 124 and a back end 126 of the support structure 100 can remain open or unobstructed in order to insert and remove one or more devices 25. As can be seen, the sidewalls 120A-B, the lower wall 122, and/or the upper wall 110 may include openings or be perforated to permit heat to transfer to the device more easily. The leg elements 112 can depend from the lower wall 122.

When disposed within the cavity 32 of the thermal chamber 30, the heat exchanger 50 can be disposed anywhere on the support structure 100. In one example, the heat exchanger 100 can be disposed along the upper end 110 of the support structure 100 to maximize the heat transfer from the heating elements 102 of the thermal chamber 30.

To accommodate multiple flow passages and/or devices, a manifold 130 can be provided, for example, in between the heat exchanger 50 and the devices 25. The manifold 130 includes an inlet end (not shown) to couple to the heat exchanger 50 and an outlet end 132 and a manifold passageway in communication with the inlet end and the outlet end 132. In one example, a single inlet end may be coupled to the outlet end of the heat exchanger. The outlet end 132 can include a plurality of ports 132A, each port 132A for coupling to a corresponding fluid conduit 55. A single fluid conduit 55 may couple to more than one port 132A or a single port 132A may be coupled to more than one conduit 55. Not all of the ports 132A need to be used for each cleaning cycle; the ports 132A may remain unused and can be plugged. The manifold 130 can be attached to the support structure 100. However, to accommodate for relative thermal expansion between the manifold 130 and the support structure 100, the manifold 130 can just be placed on brackets (not shown) along the sidewalls 120A-B of the support structure 100 and remain unattached. In one example, only one end of the manifold 130 can be attached to the support structure 100, such as, e.g., mechanically fastened, thereby allowing the opposite free end to be placed on a slider to allow for thermal expansion. It may also be contemplated that the manifold 130 is configured to thermally expand at the same rate as the support structure and thus may be attached at both ends.

The support structure 100 may include one or more shelves, such as a first shelf 140 and a second shelf 142, each for supporting one or more devices 25. It may be contemplated that the support structure 100 may include a single shelf or three, four, five, or more shelves. Further, it may be contemplated that a single manifold, such as manifold 130, can be coupled to a plurality of fluid conduits (three shown) to provide heated fluid to multiple flow passages of a device 25. The fluid conduits 55 can be coupled to more than one device on the same shelf or on different shelves.

In another example, the second shelf 142 may also include a second manifold 144, whereas the first shelf 140 includes the first manifold 130. The second manifold 144 can be of a similar configuration as the first manifold 130, such as having a multiple outlet ports for coupling to fluid conduits to be coupled to the devices. The first and second manifolds 130, 144 can be coupled to one another by a transfer conduit 145 such that the manifolds 130, 144 and the transfer conduit 145 are in fluid communication. Here, for example, the first manifold 130 can provide heated fluid to the device 25 on the first shelf 140, and the second manifold 144 can provide heated fluid to another device 25 on the second shelf 142. It may be contemplated that the first and second manifolds 130, 144 can provide heated fluid to devices on the same shelf The shelves 140, 142 can be perforated with openings to permit more effective transfer of heat to the devices.

In one example, the fluid supply 35 may originate from within the thermal chamber instead of being supplied from external to the thermal chamber. To this end, a conduit and/or a heat exchanger can have an inlet end to receive the heated air within the thermal chamber. In other words, the thermal chamber can heat the air. A fluid pump or fan may facilitate the movement of the heated air within the thermal chamber to within the conduit such that the heated air is introduced to the flow passages of the devices. After the passage of the heat air through the device, the air can be reintroduced into the thermal chamber.

In one example, the devices can be heated by the thermal chamber for the first period of time. After being cooled, fluid supply at about the second temperature can be introduced within the flow passages of the devices for the second period of time. For example, the fluid supply can be heated separately, such as, e.g., by a furnace and/or heat exchanger.

FIG. 4 illustrates one example of a system 150 having the fluid heated prior to entry into the thermal chamber 151. In other words, the temperature of the fluid supply may be primarily heated independent to the temperature of the thermal chamber. To this end, the temperature of the fluid supply can be selectively greater, lesser or substantially equal to the temperature of the thermal chamber. The fluid may be heated by an auxiliary heat source 153 such as, e.g., a gas or electric furnace or a heat exchanger. The heat source may be tied to an existing heat source having suitable heat capacity. The heat source 153 can include a heated conduit 174 having an inlet coupled to the passageway 42 and an outlet coupled to another passageway 172 that is extended within the cavity 152 of the thermal chamber 151. The passageway 172 is coupled to the manifold 130 with may have one or more conduits for coupling to internal passages of one or more devices. As shown, the manifold 130 is shown with two conduits 55 each coupled to the flow passage 20 of the devices 25. In one example, one or more devices 25 can be placed in the cavity 152 of the thermal chamber 151, and heated fluid supply such as hot air may be tapped off a gas turbine's compressor. The heated fluid supply can be regulated down to a lower pressure before entering the flow passage 20 of the devices 25 to be cleaned. The heated fluid supply from the gas turbine's compressor may contain sufficient heat, oxidizer, and flow rate for cleaning. The gas turbine's compressor would be sized and operable to supply fluid at a discharge temperature comparable to desired second temperature described above, such as about 975 degrees F.

FIG. 5 illustrates one example of a system 180 contained entirely within the cavity 182 of the thermal chamber 181. Here, the inlet 184 of the passageway 42 is exposed to the cavity instead of being outside the thermal chamber. A fluid mover 183, such as a fan or pump configured to operate in a heated environment provided by the thermal chamber, can be energized to draw heated air in the cavity 182 within the inlet 184. The fluid mover 183 can be configured to deliver the air with sufficient flow and pressure to the flow passages 20 of the device 25. Although shown with the heat exchanger 50 disposed between the inlet 184 and the flow passage 20, the system 180 may not include the heat exchanger 50 if the heated air within the cavity 182 has a sufficient temperature for its cleaning purpose.

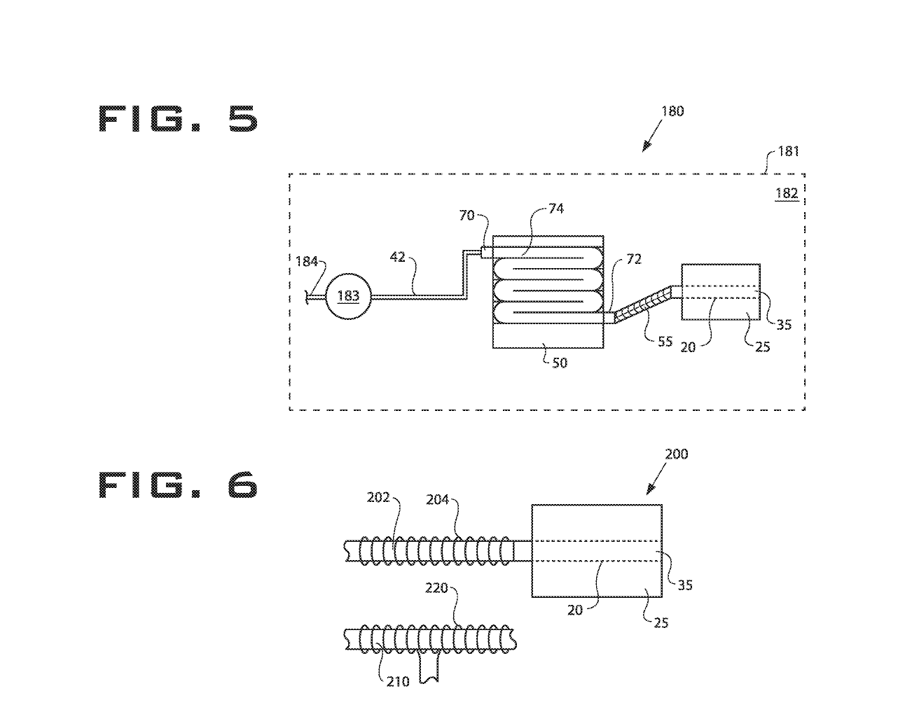

FIG. 6 illustrates one example of a system 200 having an independent mechanism for heating the supply fluid prior to entry to the flow passage. For example, the passageway 202 coupled to the flow passage 20 of the device 25 includes a conductive material 204, such as a metal wire comprising a low resistance and high permeability such as ferrous materials, coiled around the passageway 202. An inductive element 210 having a conductive material 220, such as a metal wire comprising a low resistance and high permeability such as ferrous materials, has a coiled arrangement. The conductive material 220 can be electrically coupled to AC voltage source. To this end, when AC current is supplied to the conductive material 220, a magnetic field is formed and can induce a current within the conductive material 204 to generate heat energy around the passageway 202. The heat energy generated can be a factor of the size of the conductive material 204, the number of coil turnings and/or its coil radius, the conductive material of the passageway 202, the flow rate and conductivity of the fluid supply, as well as, the intensity of the magnetic field generated by the inductive element 210. The inductive heating can take place external to a thermal chamber or within a cavity of a thermal chamber. Similarly, as can be appreciated by those of ordinary skill in the art each device 25 may also be heated through inductive heating by wrapping the external device with a conductive material having a coiled arrangement (not shown) sufficient for a suitable temperature.

### INDUSTRIAL APPLICABILITY

The cleaning systems and processes described herein can be used to clean any flow passages of a plurality dirty devices having a coated lining as a result of carrying liquid fuel or gas. For example, the dirty devices can have one or more flow passages undesirably clogged with deposit layers of carbon, sulfur, traces of metal, hydrocarbons, or any combination thereof The systems and processes can improve the quality and timeliness of cleaning overhauled devices, such as fuel injectors. Further, with the primary use of air and heat, the systems and processes described herein can be in compliance with various chemical use and disposal regulations.

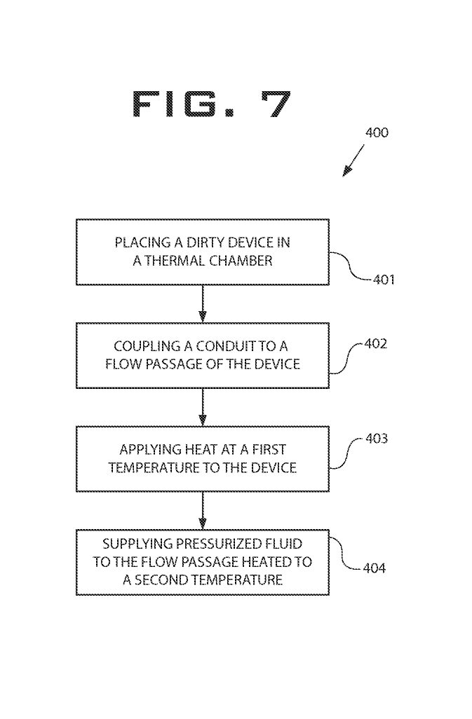

FIG. 7 is a schematic illustrating one example of a cleaning process 400. The thermal chamber may initially be at ambient temperature. The thermal chamber may have the support structure within its cavity such as shown in FIG. 2. If not in there, the operator can have the support structure placed within the thermal chamber. In one step (401), a dirty device can be placed within the thermal chamber. For example, one or more devices can be placed on one or more shelves of the support structure. In another step (402), a conduit can be coupled to the flow passage of the device to permit pressurized fluid to pass therethrough to the flow passage for cleaning. For example, the first end of the conduit can be coupled to a corresponding port of the manifold. The second end of the conduit can be coupled to a corresponding port on the inlet end of the flow passage of the device. The rest of the fluid conduits can be coupled between the manifold and the flow passage of the devices in a similar manner. The manifold can be moved to the front of the support structure for accessibility so that an operator can more easily reach the ports of the manifold.

In another step (403), heat at a first temperature can be applied to a device for a first period of time. For example, the thermal chamber can then be fully enclosed, for example, by shutting its door. The thermal chamber can be activated to reach its processing temperature, such as, e.g., about 975±25 degrees F. (524±14 degrees C.) during a ramp up stage. After activation of the thermal chamber, the fluid supply can be activated. For example, the regulator can be monitored to ensure that the fluid supply from the fluid source may be pressurized to a desired pressure, such as, e.g., about 5-10 psi (0.3-0.7 bar). To this end, the device can begin to heat on the outside and the fluid flowing in the flow passage can heat the device on the inside. The fluid supply can travel within the flow passage and exit out of the outlet end of the flow passage into the cavity of the thermal chamber. Effluents such as any odor or particulates after exiting the flow passage may be evacuated from the thermal chamber. In one example, the effluents may be evacuated through the same entry point as the passageway enters the furnace. Optionally, the effluents may be evacuated through a fume hood placed above the furnace or above just the entry point.

In another step (404), pressurized fluid at a second temperature may be supplied to a flow passage of the device for a second period of time, where at least a portion of the first period of time and the second period of time overlap one another. For example, during reaching the processing temperature of the thermal chamber, the flow can be heated to its temperature, such as, e.g., about 950 degrees F. (510 degrees C.). In one example, the heat exchanger described herein can be utilized to heat the fluid supply to its effective temperature. In another example, heat at the first temperature from the thermal chamber can be provided to the device and to the heat exchanger to heat the pressurized fluid to the second temperature. The thermal chamber may be operable to maintain the processing temperature for a period of time, such as, e.g., about a minimum of an hour or more. Thus, the device can be heated on the outside and the inside simultaneously. After the period of time, the thermal chamber may be deactivated and the thermal chamber and thus the devices are permitted to cool during a ramp down period. The fluid conduits can be decoupled from the devices and the manifold (if needed). The devices are then evaluated to ensure that flow performance and pressure drop through each of the flow passages are adequate.

It will be apparent to those skilled in the art that various modifications and variations can be made in the disclosed fluid control system without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims and their equivalents.

What is claimed is:

1. A cleaning system for one or more flow passages of a device, comprising:
a thermal chamber to receive a device, the thermal chamber operable to heat the device to a first temperature;
a fluid supply to provide a pressurized fluid, the fluid comprising an oxidizer;
a heat exchanger operable to heat the fluid to a second temperature; and
one or more conduits coupled to the heat exchanger and at least partially disposed within the thermal chamber to couple to one or more corresponding flow passages of the device, wherein the fluid supply, the heat exchanger, the conduit, and the flow passage of the device are in fluid communication with one another, wherein the conduit is configured to carry fluid heated at the second temperature to the flow passage of the device.

2. The system of claim 1, wherein the heat exchanger is disposed within the thermal chamber such that the thermal chamber is operable to provide heat to the fluid.

3. The system of claim 2, further comprising a support structure disposed within the thermal chamber having an upper end, wherein the heat exchanger is placed along the upper end of the support structure.

4. The system of claim 2, wherein the heat exchanger remains uncoupled to the upper end of the support structure.

5. The system of claim 4, wherein the support structure further comprises two or more lateral sidewalls coupled to the upper end and one or more shelves extending between at least two sidewalls to support the device.

6. The system of claim 2, further comprising a manifold having an inlet port in fluid communication with an outlet of the heat exchanger and a plurality of outlet ports coupled to corresponding conduits.

7. The system of claim 6, further comprising a support structure disposed within the thermal chamber, wherein at least one end of the manifold remains unattached to the support structure.

8. The system of claim 7, wherein the conduit is positionable entirely within the thermal chamber.

9. The system of claim 1, further comprising a fluid source operable to provide air as the fluid, and a fluid passageway coupled between the fluid source and the heat exchanger.

10. The system of claim 1, wherein the heat exchanger is disposed outside the thermal chamber.

11. The system of claim 10, wherein the heat exchanger comprises an inductive coil wrapped around the conduit.

12. The system of claim 1, wherein the fluid supply is from within the thermal chamber.

13. A hot air cleaning system for one or more passages of one or more fuel injectors, comprising:
a furnace to receive at least one fuel injector, the furnace operable to heat the at least one fuel injector to a first temperature;
a fluid supply to provide a pressurized fluid, the fluid comprising an oxidizer;
a heat exchanger disposed within the furnace and configured to carry the fluid, the heat exchanger operable to heat the fluid to a second temperature; and
one or more conduits coupled between the heat exchanger and corresponding one or more passages of the at least one fuel injector, wherein the fluid supply, the heat exchanger, the conduit, and the passage of the at least one fuel injector are in fluid communication with one another,
wherein the furnace is operable to provide heat at the first temperature to the device and to the heat exchanger to heat the fluid to the second temperature.

14. The system of claim 13, further comprising a support structure disposed within the furnace having an upper end, wherein the heat exchanger is placed along the upper end of the support structure.

15. The system of claim 14, further comprising a manifold having an inlet port in fluid communication with an outlet of the heat exchanger and a plurality of outlet ports coupled to corresponding conduits.

16. The system of claim 14, further comprising a fluid source to supply the fluid supply, a fluid passageway coupled between the fluid source and the heat exchanger, a pressure regulator coupled to the fluid passageway, and a filter coupled to the fluid passageway, wherein the pressure regulator and the filter remain external to the furnace and the fluid passageway is extendable within the furnace.

17. A process of cleaning a flow passage of a device, wherein the device is disposed within a thermal chamber operable to provide heat at a first temperature, wherein a supply of pressurized fluid including an oxidizer is coupled to the flow passage of the device, comprising:
applying heat at a first temperature to a device for a first period of time; and
supplying pressurized fluid at a second temperature to a flow passage of the device for a second period of time, wherein at least a portion of the first period of time and the second period of time overlap one another.

18. The process of claim 17, wherein a heat exchanger is provided within the thermal chamber, wherein the supplying step further comprises supplying pressurized fluid at a third temperature to the heat exchanger where the pressurized fluid is heated to the second temperature prior to being supplied to the flow passage of the device, wherein the applying step further comprises applying heat at the first temperature to the device and to the heat exchanger such that the pressurized fluid is heated to the second temperature.

19. The process of claim 18, wherein the supplying step further comprises coupling a conduit between a heat exchanger and the flow passage of the device, wherein the conduit is configured to carry the fluid heated to the second temperature.

20. The process of claim 18, wherein the supplying step further comprises maintaining the pressurized fluid at a desired pressure and filtering the fluid prior to being supplied to the flow passage.
